(19) United States
(12) Patent Application Publication
(10) Pub. No.: US 2024/0343257 A1
(43) Pub. Date: Oct. 17, 2024

(54) INFORMATION PROCESSING SYSTEM, INFORMATION PROCESSING METHOD, AND NON-TRANSITORY STORAGE MEDIUM

(71) Applicants: TOYOTA JIDOSHA KABUSHIKI KAISHA, Toyota-shi (JP); DENSO TEN Limited, Kobe (JP)

(72) Inventors: Rie MURAI, Chiba-shi (JP); Jun Hioki, Nagakute-shi (JP); Tomonari Yamaguchi, Miyoshi-shi (JP); Takanori Imazu, Anjo-shi (JP); Yohhei Okamoto, Kobe-shi (JP); Syohgo Honda, Kobe-shi (JP)

(73) Assignees: TOYOTA JIDOSHA KABUSHIKI KAISHA, Toyota-shi (JP); DENSO TEN Limited, Kobe (JP)

(21) Appl. No.: 18/624,422

(22) Filed: Apr. 2, 2024

(30) Foreign Application Priority Data
Apr. 14, 2023 (JP) 2023-066443

(51) Int. Cl. B60W 50/00; B60K 35/10; B60R 25/24; B60W 30/06

(52) U.S. Cl. CPC B60W 50/0098; B60K 35/10; B60R 25/24; B60W 30/06; B60K 2360/573; B60W 2050/0083

(57) ABSTRACT

An information processing system includes: a search system mounted on a vehicle and configured to search for a mobile information terminal owned by a user before the user of the vehicle gets on the vehicle; and a setting system configured to reflect an item set in advance by the user in control of the vehicle, when specific terminal information included in the searched mobile information terminal matches terminal information registered on the setting system.

### CROSS-REFERENCE TO RELATED APPLICATION

This application claims priority to Japanese Patent Application No. 2023-066443 filed on Apr. 14, 2023, incorporated herein by reference in its entirety.

### BACKGROUND

### 1. Technical Field

The present invention relates to an information processing system, an information processing method, and a non-transitory storage medium.

### 2. Description of Related Art

For example, the information processing system described in Japanese Unexamined Patent Application Publication No. 2016-215817 (JP 2016-215817 A) identifies a user of a vehicle by communicating with a mobile information terminal and recognizing specific terminal information included in the mobile information terminal. Then, an item set in advance by the identified user is reflected in control of the vehicle.

### SUMMARY

In a technique disclosed in JP 2016-215817 A, a user is identified after the user gets on a vehicle. Therefore, an item set in advance by the user cannot be reflected in control of the vehicle before the user gets on the vehicle.

An information processing system according to a first aspect of the present invention includes a search system that is mounted on a vehicle and searches for a mobile information terminal owned by a user, before the user of the vehicle gets on the vehicle, and a setting system that reflects an item set in advance by the user in control of the vehicle, when specific terminal information included in the searched mobile information terminal matches terminal information registered on the setting system.

An information processing method according to a second aspect of the present invention performs searching, by one or more processors mounted a vehicle, for a mobile information terminal before a user of the vehicle gets on the vehicle, and reflecting, by the one or more processors, an item set in advance by the user in control of the vehicle, when specific terminal information included in the searched mobile information terminal matches terminal information registered on the vehicle.

A non-transitory storage medium storing instructions that are executable by one or more processors mounted on a vehicle and that cause the one or more processors to perform functions according to a third aspect of the present invention is configured to cause a computer to search for a mobile information terminal before a user of the vehicle gets on the vehicle, and reflect an item set in advance by the user in control of the vehicle, when specific terminal information included in the searched mobile information terminal matches terminal information registered on the vehicle.

The item set in advance by the user can be reflected in the control of the vehicle before the user gets on the vehicle.

### BRIEF DESCRIPTION OF THE DRAWINGS

Features, advantages, and technical and industrial significance of exemplary embodiments of the invention will be described below with reference to the accompanying drawings, in which like signs denote like elements, and wherein:

FIG. 1 is a diagram schematically showing a configuration of an information processing system according to an embodiment; and

FIG. 2 is a flowchart showing a procedure of processing executed by the information processing system.

### DETAILED DESCRIPTION OF EMBODIMENTS

Hereinafter, an information processing system, an information processing method, and a non-transitory storage medium according to an embodiment will be described with reference to the drawings.

### Configuration of Information Processing System

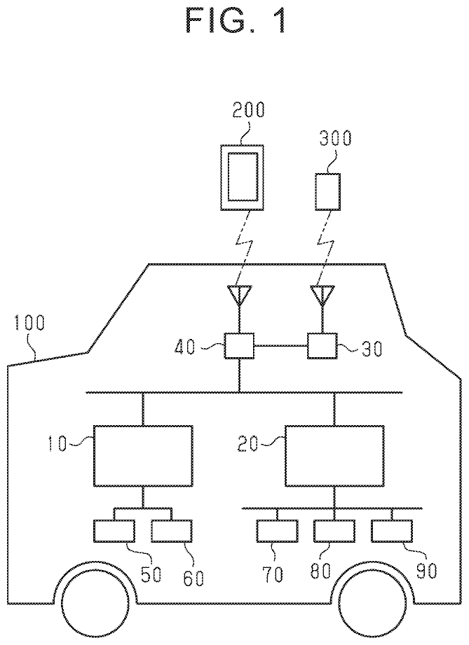

As shown in FIG. 1, the information processing system of a vehicle 100 includes a setting system 10, a remote parking system 20, an authentication system 30, and a Bluetooth (BT) module 40. Each of these systems and modules is a computer including a central processing unit (CPU), a memory, an input interface, an output interface, and the like. The CPU executes a program stored in the memory, thereby executing various kinds of system control. Also, each of these systems and modules is connected to an in-vehicle network, allowing them to communicate with each other.

The authentication system 30 performs authentication of an electronic key 300 of the vehicle 100 carried by a user of the vehicle 100. The electronic key 300 is a key used to unlock and lock a door of the vehicle 100 and to start the system.

The BT module 40 performs wireless communication based on Bluetooth (registered trademark) standard with a mobile information terminal 200 owned by the user. The mobile information terminal 200 is, for example, a smartphone, a tablet, and the like.

The setting system 10 is a system that reflects an item set in advance by the user in control of the vehicle 100. The items set in advance by the user include a driving position, such as a position of a seat or a steering wheel, and content displayed on a multimedia display and an instrument cluster installed inside the vehicle. Hereinafter, the items set in advance by the user are referred to as my settings. My settings is registered in a memory for each specific terminal information included in the mobile information terminal 200. The terminal information is used for user authentication of the user who owns the mobile information terminal 200.

A body control system 50 that controls an actuator related to the driving position such as the position of the seat and the steering wheel, and a display control system 60 that controls the content displayed on the multimedia display and the instrument cluster installed inside the vehicle are connected to the setting system 10.

The remote parking system 20 is a system in which a user operates the mobile information terminal 200 from outside the vehicle to perform entering and exiting of the vehicle 100. A signal related to information around the vehicle and a signal related to an operating state of the mobile information terminal 200 are input to the remote parking system 20. Furthermore, various actuator systems for performing remote parking, for example, a powertrain system 70, a brake system 80, a steering system 90, and the like are connected to the remote parking system 20.

### Processing Executed by Information Processing System

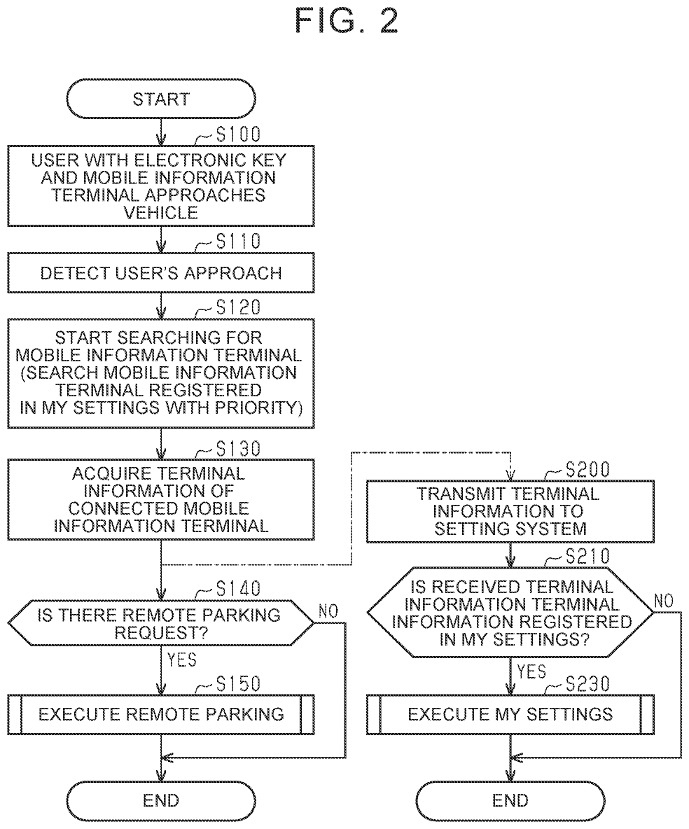

FIG. 2 shows a procedure of processing executed by the information processing system of the vehicle 100. Note that in the following, a step number of each process is expressed by a number prefixed with “S”.

In the process shown in FIG. 2, first, the user of the vehicle 100 with the electronic key 300 and the mobile information terminal 200 approaches the vehicle 100 (S100).

Next, the authentication system 30 detects the user's approach to the vehicle 100 by authenticating the electronic key 300 (S110).

Then, the BT module 40 starts searching for the mobile information terminal 200 (S120). When the authentication system 30 authenticates the electronic key 300 in the process of S110, the authentication system 30 instructs the BT module 40 to start searching. In this way, since the BT module 40 starts searching when the electronic key 300 is authenticated, the searching for the mobile information terminal 200 is started before the user gets on the vehicle. When searching for the mobile information terminal 200, the BT module 40 preferentially searches for the mobile information terminal 200 that includes the terminal information registered in the my settings.

Next, the BT module 40 acquires the terminal information of the mobile information terminal 200 connected after the searching (S130).

After acquiring the terminal information of the mobile information terminal 200 in this manner, the remote parking system 20 determines whether there is a request for the remote parking (S140). Then, when the remote parking system 20 determines that there is a request for the remote parking (S140: YES), the remote parking system 20 executes the remote parking using the mobile information terminal 200 that includes the acquired terminal information (S150). Subsequently, when the remote parking is completed, or when a negative determination is made in the process of S140, the remote parking system 20 ends the process.

In contrast, in the process of S130 described above, when the BT module 40 acquires the terminal information of the connected mobile information terminal 200, the BT module 40 transmits the terminal information to the setting system 10 (S200).

The setting system 10 that has received the terminal information determines whether the received terminal information is terminal information registered in the my settings (S210).

Next, the setting system 10 collates whether the received terminal information matches any of a plurality of terminal information registered in the my settings (S210).

Then, when the setting system 10 determines that the received terminal information is terminal information registered in the my settings (S210: YES), the setting system 10 executes the my settings corresponding to the terminal information (S230). By executing the my settings, the items set in advance by the user are reflected in the control of the vehicle 100. Then, when the execution of the my settings is completed, or when a negative determination is made in the process of S210, the setting system 10 ends the process.

### Operation and Effects

The operation and effects of the present embodiment will be described.

(1) Before the user of the vehicle 100 gets on the vehicle 100, the mobile information terminal 200 owned by the user is searched. Then, when the specific terminal information included in the searched mobile information terminal 200 matches the terminal information registered on the vehicle setting system 10, the items set in advance by the user are reflected in the control of the vehicle 100. Therefore, the items set in advance by the user can be reflected in the control of the vehicle 100 before the user gets on the vehicle 100.

(2) The terminal information of the mobile information terminal 200 is shared with the remote parking system that is another system different from the setting system 10 and that requires the terminal information. Thus, when the other system is a system that requires the terminal information described above, there is no need to provide a search system for searching for the mobile information terminal 200 for each another system. Therefore, a system configuration can be simplified.

(3) In S120 shown in FIG. 2, the mobile information terminal 200 that includes the terminal information registered on the vehicle setting system 10 is searched with priority. Thus, authentication of the mobile information terminal 200 is performed at an early stage. Therefore, the items set in advance by the user can be reflected in the control of the vehicle 100 at an earlier stage.

(4) When searching for the mobile information terminal 200, an upper limit time is often set for search time. Therefore, in some cases, the search time may time out before connecting to the mobile information terminal 200 that includes the terminal information registered in the my settings, and the my settings may not be able to be executed. In this point, in the present embodiment as described above, the mobile information terminal 200 that includes the terminal information registered on the vehicle setting system 10 is searched with priority. Therefore, before the search time times out, it becomes possible to connect to the mobile information terminal 200 that includes the terminal information registered in the my settings, and becomes possible to appropriately execute the my settings.

(5) When the authentication system 30 completes authentication of the electronic key 300 by the process of S110 shown in FIG. 2, the searching for the mobile information terminal 200 is started (S120). Therefore, compared to a case where the searching for the mobile information terminal 200 is always performed, electric power consumption required for searching for the mobile information terminal 200 can be suppressed.

### Correspondence

In S120 shown in FIG. 2, the BT module 40 performs a process for searching for the mobile information terminal 200 owned by the user from the vehicle 100, before the user of the vehicle 100 gets on the vehicle. In the present embodiment, the BT module 40 is an example of the search system. In addition, in S210, S230 shown in FIG. 2, when the specific terminal information included in the searched mobile information terminal 200 matches the terminal information registered on the vehicle, the setting system 10 executes the my settings that reflects the items set in advance by the user in the control of the vehicle 100. In the present embodiment, the setting system 10 is an example of a setting system. Furthermore, a program that causes the BT module 40 and the setting system 10 to execute the process shown in FIG. 2 is an example of an information processing program.

### Modifications

Note that the above embodiment can be modified and implemented as follows. The above embodiment and the following modifications can be implemented in combination with each other within a technically consistent range.
Although the mobile information terminal 200 that includes the terminal information registered on the vehicle setting system 10 has been searched with priority, such a preferential searching need not be performed. Even in this case, operation and effects other than those described in (3) and (4) can be obtained.
When the authentication system 30 completes the authentication of the electronic key 300, the searching for the mobile information terminal 200 is started. In addition, the searching for the mobile information terminal 200 may be always performed. Even in this case, operation and effects other than those described in (5) can be obtained.
The items set in advance by the user include the driving position, such as the position of the seat or the steering wheel, and the content displayed on the multimedia display and the instrument cluster installed inside the vehicle, but another item can be included.
Although the search system for searching for the mobile information terminal from the vehicle 100 is a system that performs wireless communication based on Bluetooth standard, the search system may be a system that performs wireless communication based on another standard.
Although the another system that shares the terminal information of the mobile information terminal 200 is the remote parking system, other systems may be used. Examples of the other systems include the followings.

Example 1: A system that automatically transmits destination information set by a navigation app installed in the mobile information terminal 200 to a vehicle navigation device.

Example 2: A system that preferentially performs hands-free connection, audio connection, and video connection to the mobile information terminal 200 that includes the acquired terminal information.

Example 3: A system that uses the acquired terminal information to identify a vehicle occupant and that provides service to the identified occupant. Note that the service for the identified occupant includes, for example, the following (a) to (d).
(a) Displaying a hospitality guide on the application installed in an occupant's mobile information terminal 200.
(b) Displaying recommended content for the identified occupant on the application installed in the mobile information terminal 200.
(c) Displaying a user interface for switching the my settings on the application installed in the mobile information terminal 200.
(d) A system that automatically sets rear seat entertainment, rear seat position, and the like when the identified occupant is a rear seat occupant.

### APPENDIXES

The technical ideas that can be understood from the above embodiment and modifications will be described.

[Appendix 1] An information processing system, comprising: a search system mounted on a vehicle for searching for a mobile information terminal owned by a user, before the user of the vehicle gets on the vehicle; and a setting system for reflecting an item set in advance by the user in control of the vehicle, when specific terminal information included in the searched mobile information terminal matches terminal information registered on the setting system.

[Appendix 2] The information processing system according to appendix 1, wherein the terminal information is shared with another system different from the setting system.

[Appendix 3] The information processing system according to appendix 2, wherein other system is a remote parking system in which the vehicle is operated by using the mobile information terminal.

[Appendix 4] The information processing system according to any one of appendixes 1 to 3, wherein the search system is a system for preferentially searching for the mobile information terminal that includes the terminal information registered on the setting system.

[Appendix 5] The information processing system according to any one of appendixes 1 to 4, wherein the information processing system includes an authentication system for authenticating an electronic key of the vehicle, and the search system starts searching for the mobile information terminal when the authentication system completes authentication of the electronic key.

What is claimed is:

1. An information processing system comprising:
a search system mounted on a vehicle and configured to search for a mobile information terminal owned by a user before the user of the vehicle gets on the vehicle; and
a setting system configured to reflect an item set in advance by the user in control of the vehicle, when specific terminal information included in the searched mobile information terminal matches terminal information registered on the setting system (10).

2. The information processing system according to claim 1, wherein the terminal information is shared with another system different from the setting system.

3. The information processing system according to claim 2, wherein the other system is a remote parking system in which the vehicle is operated by using the mobile information terminal.

4. The information processing system according to claim 1, wherein the search system is a system for preferentially searching for the mobile information terminal that includes the terminal information registered on setting system.

5. The information processing system according to claim 1, wherein
the information processing system includes an authentication system that authenticates an electronic key of the vehicle, and
the search system starts searching for the mobile information terminal, when the authentication system completes authentication of the electronic key.

6. An information processing method, comprising:
searching, by one or more processors mounted a vehicle, for a mobile information terminal before a user of the vehicle gets on the vehicle; and
reflecting, by the one or more processors, an item set in advance by the user in control of the vehicle, when specific terminal information included in the searched mobile information terminal matches terminal information registered on the vehicle.

7. A non-transitory storage medium storing instructions that are executable by one or more processors mounted on a vehicle and that cause the one or more processors to perform functions comprising:
searching for a mobile information terminal before a user of the vehicle gets on the vehicle; and
reflecting an item set in advance by the user in control of the vehicle, when specific terminal information included in the searched mobile information terminal matches terminal information registered on the vehicle.
